(19) United States
(12) Patent Application Publication
(10) Pub. No.: US 2020/0402192 A1
(43) Pub. Date: Dec. 24, 2020

(54) Creation of Web-Based Interactive Maps for Emergency Responders

(71) Applicant: Dahm Endeavor LLC, Monroe, MI (US)

(72) Inventors: Matthew Vincent Dahm, Monroe, MI (US); Kevin Wayne Dahm, II, Monroe, MI (US); Kevin Wayne Dahm, Monroe, MI (US); Jeanmarie Dahm, Monroe, MI (US)

(21) Appl. No.: 16/447,740

(22) Filed: Jun. 20, 2019

(51) Int. Cl. G06Q 50/26; G06F 16/29; G06T 11/60

(52) U.S. Cl. CPC G06Q 50/265; G06T 2200/24; G06T 11/60; G06F 16/29

(57) ABSTRACT

Methods and systems for creating web-based interactive maps for emergency responders are provided. The method may commence with receiving floor plan data and generating a floor plan of a facility. The method may continue with creating an interactive web-based map of the facility by superimposing the floor plan onto a map of an area associated with the facility. The method may further include receiving locations of assets associated with the facility. Based on the floor plan data and the locations of assets, a plurality of layers of the interactive web-based map may be created. Each layer may be labeled with icons identifying a selection of the assets. The method may further include receiving incident data associated with the facility and making one or more of the plurality of layers of the interactive web-based map available to the emergency responder based on a role of the emergency responder.

### FIELD OF THE INVENTION

The present disclosure relates to generation of web-based interactive maps of facilities and making the interactive web-based maps available to emergency responders in case of an incident.

### BACKGROUND

Interactive maps may provide first responders or dispatch center operators with real-time data needed to respond to an incident. The real-time data shown on the interactive maps may represent a street plan, historical locations of incidents, locations of equipment needed for dealing with the incident, traffic data, and so forth. However, in conventional solutions, the real-time data may be not consolidated into a single interactive map, but rather provided by a plurality of individual systems, each having its own interactive map, thus requiring the first responder or the dispatch center operator to review multiple screens of interactive maps.

When an incident occurs inside a facility, a street map and a general plan of the facility may be insufficient for firsts responders to deal with the incident quickly and efficiently. Obtaining additional information related to the building from third-party sources may be time- and effort-consuming and not practical in an emergency.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided are methods and systems for creating web-based interactive maps for emergency responders. In some example embodiments, a method for creating web-based interactive maps for emergency responders may commence with receiving floor plan data associated with a facility. The method may further include generating a floor plan of the facility based on the floor plan data. The method may continue with creating an interactive web-based map of the facility by superimposing the floor plan onto a map of an area associated with the facility. The method may further include receiving locations of assets associated with the facility. Based on the floor plan data and the locations of assets, a plurality of layers of the interactive web-based map may be created. Each layer may be labeled with icons identifying a selection of the assets.

The selection may include assets relevant to a specific emergency responder. The method may further include receiving incident data. In response to the receipt of the incident data, one or more of the plurality of layers of the interactive web-based map may be made available to the emergency responder based on a role of the emergency responder.

In some example embodiments, a system for creating web-based interactive maps for emergency responders may include a processor, a map generation unit, and a database. The processor may be configured to receive floor plan data associated with a facility and generate a floor plan of the facility based on the floor plan data. The processor may be further configured to receive locations of assets associated with the facility and receive incident data associated with the facility. The map generation unit may be configured to create an interactive web-based map of the facility by superimposing the floor plan onto a map of an area associated with the facility. The map generation unit may be configured to create a plurality of layers of the interactive web-based map. Each layer may be labeled with icons identifying a selection of the assets. The selection may correspond to the role of the emergency responder. The processor may be further configured to make one or more of a plurality of layers of the interactive web-based map available to an emergency responder based on a role of the emergency responder in response to the receipt of the incident data.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF DRAWINGS

Embodiments are illustrated by way of example and not limitation in the figures of the accompanying drawings, in which like references indicate similar elements and in which:

FIG. 1 illustrates an environment within which a system and methods for creating web-based interactive maps for emergency responders can be implemented, in accordance with some example embodiments.

FIG. 2 is a block diagram showing various modules of a system for creating web-based interactive maps for emergency responders, in accordance with certain embodiments.

FIG. 3 is a flow chart illustrating a method for creating web-based interactive maps for emergency responders, in accordance with an example embodiment.

FIG. 4 is a block diagram schematically showing communications between various parties and a system for creating web-based interactive maps for emergency responders, according to an example embodiment.

FIG. 5 is a block diagram schematically showing communications between various parties and a system for creating web-based interactive maps for emergency responders for threats occurring at highly secure locations.

FIG. 6 is a block diagram schematically representing a user interface shown on a user device of a site administrator, according to an example embodiment.

FIG. 7 is a block diagram schematically representing a user interface shown on a user device of an emergency responder, according to an example embodiment.

FIG. 8 shows a user interface representing a scaled-up view of a web-based interactive map, according to an example embodiment.

FIG. 9 shows a user interface providing a web-based interactive map with a widget for marking a room in a building, according to an example embodiment.

FIG. 10 is a schematic diagram representing a user interface shown on a user device of a site administrator or an emergency responder, according to an example embodiment.

FIG. 11 is a diagrammatic representation of a computing device for a machine in the exemplary electronic form of a computer system, within which a set of instructions for causing the machine to perform any one or more of the methodologies discussed herein can be executed.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown as block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form.

The present disclosure provides methods and systems for creating web-based interactive maps for emergency responders. The system may have access to floor plan data and locations of assets inside and outside of a facility. For example, the floor plan data may be stored to a database by an approved user associated with the facility or an area where the facility is situated. The assets may include water hookups, lock boxes, flammable chemicals, fire hydrants, and so forth. The system may use the floor plan data to generate a floor plan of the facility. The system may further superimpose the floor plan onto a map of the area where the facility is located to create an interactive web-based map of the facility.

The system may further use the floor plan and the location of the assets to create a plurality of layers of the interactive web-based map. Each layer may be relevant to a specific emergency responder service. For example, a first layer can include locations of fire hydrants and water hookups and generated for fire fighters, a second layer can include locations of a security lock, barricade, and security gate and generated for a police department, and so forth. Emergency responders may have user devices with a mobile application associated with the system. When an incident happens at the facility, each emergency responder may be able to view a relevant layer of the interactive web-based map based on his/her role. Therefore, each of the emergency responders may only see information essential to the tasks of that responder and not distracted by information irrelevant to the role of the responder. Thus, the emergency responder may be provided with information to quickly understand the situation at the facility and tools to take appropriate actions in an efficient manner.

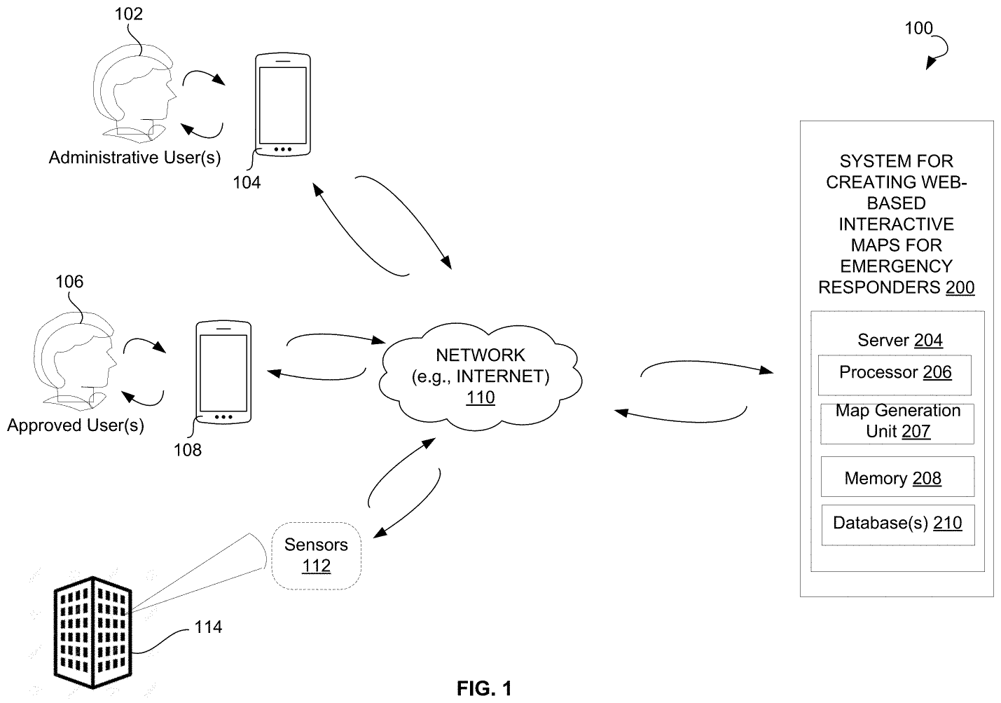

Referring now to the drawings, FIG. 1 illustrates a simplified exemplary environment 100 within which methods and systems for creating web-based interactive maps for emergency responders can be implemented. The environment 100 may include a data network 110, administrative users 102, user devices 104 associated with the administrative users 102, approved users 106, user devices 108 associated with the approved users 106, a network 110, a system 200 for creating web-based interactive maps for emergency responders, also referred to as a system 200, and, optionally, sensors 112 associated with facilities 114. The user devices 104 and 108 may include a smartphone, a tablet personal computer, a personal wearable device, a computing device, and so forth.

The data network 110 may include the Internet, a computing cloud, Representational State Transfer services cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network may include a network of data processing nodes, also referred to as network nodes, that are interconnected for the purpose of data communication.

In exemplary embodiments, the system 200 may include a central component residing on a server 204 and one or more client applications residing on one or more user devices 104 and 108 and communicating with the central component via the network 110. Users may communicate with the system 200 via a client application available through the user devices 104 and 108.

The system 200 may comprise software application(s) for receiving, processing, analyzing, and outputting data to and from the sensors 112 and/or user devices 104 and 108. In exemplary embodiments, at least some components of the system 200 may operate on one or more cloud computing devices or servers. The server 204 may include at least one processor 206, a map visualization unit 207, a memory 208, and a database(s) 210. In various embodiments, the system 200 may be installed on a user device or may be provided as a cloud service residing in a cloud storage.

The system 200 may further be in communication with administrative users 102, approved users 106, and sensors 112. There may be additional components in communication with the system 200 than those depicted in exemplary FIG. 1. For example, though not depicted in exemplary FIG. 1, system 200 may further be in communication with one or more emergency response services, such as a police department, a fire department, an emergency medical service, and so forth.

In various embodiments, the administrative users 102 may access data from the system 200 on the user device 104, which is in communication with the system 200 via the network 110. The user device 104 may be any computing device with a graphical user display and input mechanisms available to administrative user 102. Further, the user device 104 may be a wireless-enabled device. In addition, system 200 may send alerts to the user device 104 in the form of a pop-up alert, text message, email message, phone call, or any other means of communicating with the user device 104.

The approved users 106 may also access data from the system 200 on the user device 108, which is in communication with the system 200 via the network 110. The user device 108 may be any computing device with a graphical user display and input mechanisms available to the approved user 106. Further, the user device 108 may be a wireless-enabled device. In exemplary embodiments, the system 200 may send alerts to the user device 108 in the form of a pop-up alert, text message, email message, phone call, or any other means of communicating with the user device 108.

As discussed herein, the facility 114 may be any physical space with or without a plurality of sensors 112 installed therein or on surrounding grounds. The sensors 112, if present, may be in communication with the system 200 via the network 110. The sensors 112 may be any type of sensor, such as mobile phones uploading incident related data, chemical sensors, heat sensors, motion sensors, and so forth.

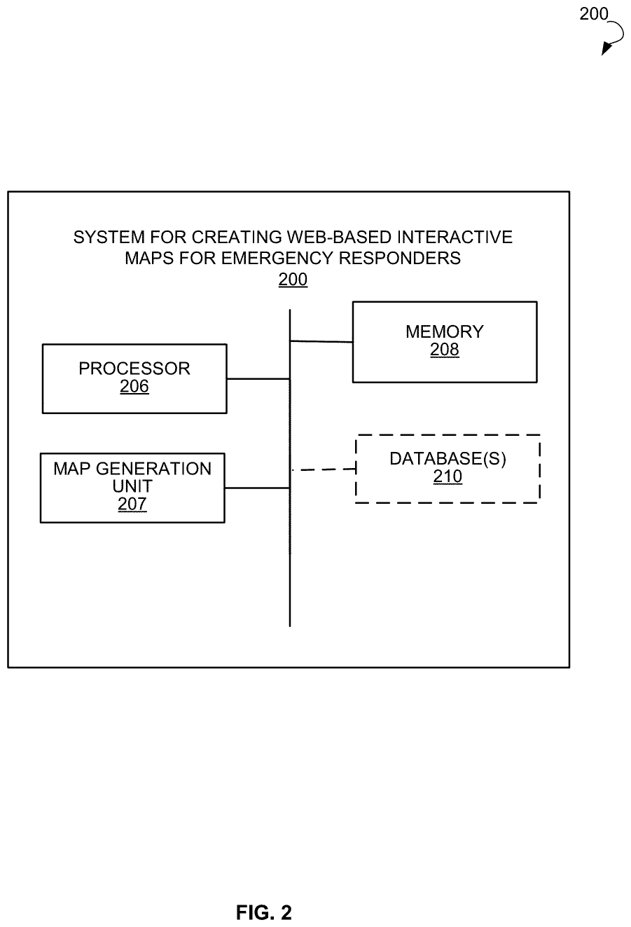

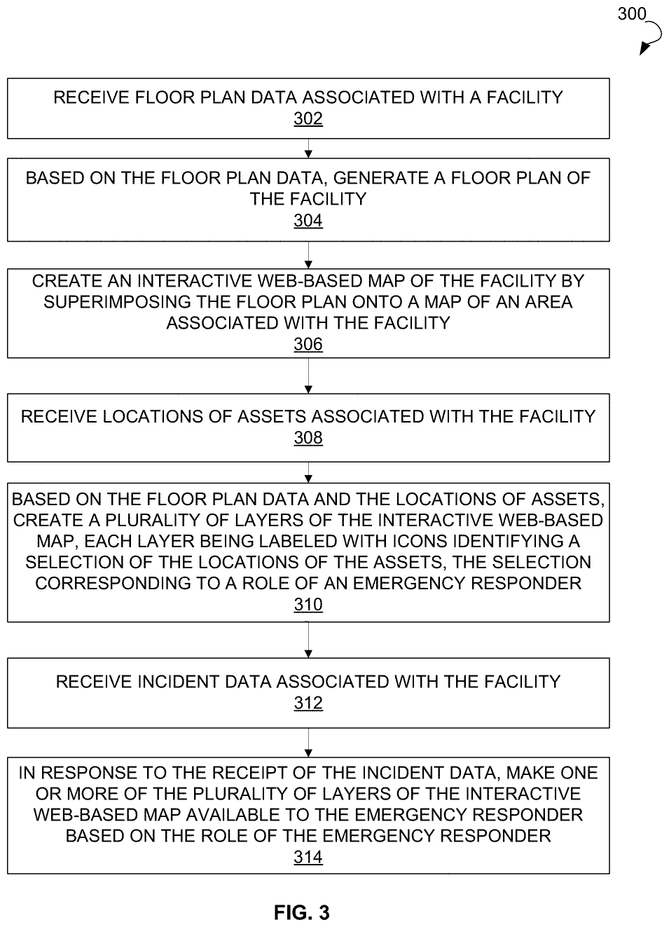

FIG. 2 is a block diagram showing various modules of a system 200 for creating web-based interactive maps for emergency responders, in accordance with certain embodiments. Specifically, the system 200 may include a processor 206, a map generation unit 207, a memory 208, and a database(s) 210. In an example embodiment, the processor 206 and the map generation unit 207 may be any suitable hardware processor for executing the software program on the server 204. Each of the processor 206 and the map generation unit 207 may include a programmable processor, such as a microcontroller, central processing unit (CPU), and so forth. In other embodiments, the processor 206 may include an application-specific integrated circuit or programmable logic array, such as a field programmable gate array, designed to implement the functions performed by the system 200. In an example embodiment, the functionalities of the map generation unit 207 may be performed by the processor 206. The memory 208 may include static and/or dynamic memory. The database(s) 210 may be any data structure capable of containing information for use by the system 200. The database(s) 210 may include computer-readable instructions for execution by processor 206. The operations performed by the components of the system 200 are described in detail with reference to FIG. 3.

FIG. 3 is a flow chart illustrating a method 300 for creating web-based interactive maps for emergency responders, in accordance with certain embodiments. In some embodiments, the operations may be combined, performed in parallel, or performed in a different order. The method 300 may also include additional or fewer operations than those illustrated. The method 300 may be performed by processing logic that may comprise hardware (e.g., decision making logic, dedicated logic, programmable logic, and microcode), software (such as software run on a general-purpose computer system or a dedicated machine), or a combination of both.

The method 300 may commence with receiving floor plan data associated with a facility at operation 302. The facility may include one of the following: a school, a place of worship, a business, a military facility, a Department of Defense (DoD) contractor, and so forth.

The method 300 may further include generating a floor plan of the facility based on the floor plan data at operation 304. The floor plan may be generated based on data received from a facility administrator. In another example embodiment, the floor plan may be automatically generated using imagery received from a third party. The method 300 may continue with creating an interactive web-based map of the facility at operation 306. The interactive web-based map may be created by superimposing the floor plan onto a map of an area associated with the facility.

The method 300 may further include receiving locations of assets associated with the facility at operation 308. The assets associated with the facility may include one or more of the following: a water hookup, a lock box, a flammable chemical, an Automated External Defibrillator (AED), a gas shut off, a breaker box, a fire hydrant, a standing valve, a Heating, Ventilation, and Air Conditioning (HVAC) system, a fire extinguisher, a chemical storage, a security lock, a barricade, a security gate, and so forth.

The method 300 may include operation 310, at which a plurality of layers of the interactive web-based map may be created based on the floor plan data and the locations of assets. Each layer of the interactive web-based map may be labeled with icons identifying a selection of the assets. The selection may correspond to a role of an emergency responder. The emergency responder, also referred herein to as a first responder, may include at least one of the following: law enforcement (LE), fire department (FD), an emergency management system (EMS), police department (PD), a school administration, a trained professional, a mental health professional, company headquarters, an on-site security service, an automated cybersecurity responder, and so forth.

The method 300 may continue with receiving incident data associated with the facility at operation 312. The incident data may be provided by one or more of the following: a dispatcher, a site administrator, an approved user, and any other party. In an example embodiment, the incident data may include sensory data provided by one or more sensors installed inside or outside the facility. The one or more sensors may include one or more of the following: mobile phones uploading incident related data, chemical sensors, heat sensors, motion sensors, and so forth. The one or more sensors may be configured to locate wireless device signals transmitted by printer Wi-Fi ports, wireless devices banned from the facility, wireless devices of intruders, wireless devices of the emergency responders, and so forth.

The method 300 may further include making one or more of the plurality of layers of the interactive web-based map available to the emergency responder based on the role of the emergency responder. The one or more of the plurality of layers of the interactive web-based map may be made available in response to the receipt of the incident data. Specifically, the interactive web-based map may be displayed on a user interface associated with a mobile application. The mobile application may be running on a user device of the emergency responder. Each layer of the interactive web-based map may incorporate historical threat data relevant to the emergency responder associated with the interactive map layer.

In an example embodiment, in an incident, the interactive web-based map may be controlled by a dispatcher or a site administrator. In addition, the control of the interactive web-based map may be transferrable between the dispatcher, site administrator, and on-site command. The interactive web-based map may allow interacting with and controlling assets as well as updating asset information through icons. The updating may be performed based on interactions with the emergency responder, by marking of the web-based interactive map with a current location of a victim or a perpetrator, by controlling physical devices in the facility, connecting digitally to a video feed of a camera, displaying signals from electronic devices on the web-based interactive map, changing a status of one or more of the assets, and so forth.

The method 300 may further include compiling a threat database. The threat database may include announced threats and unannounced threats. Threat data associated with the announced threats or the unannounced threats may be received from various sources including social networks. The threat database may include unique identifiers for persons associated with threats and/or persons involved in the incident. Furthermore, the threat database may include unique identifiers associated with incident, students, employees associated with one or more incident locations, views of locations, locations of persons, incidents, images, incident reports, historical threat data, scenarios of law enforcement and dispatch involvement, records associated with clearing rooms as well as signals and devices of emergency responders, records associated with signals and locations, records related to interactions by the dispatch, and so forth. The threat database may also include severity levels assigned to threats. The threat may be classified according to its severity level and associated with a color corresponding to the severity level.

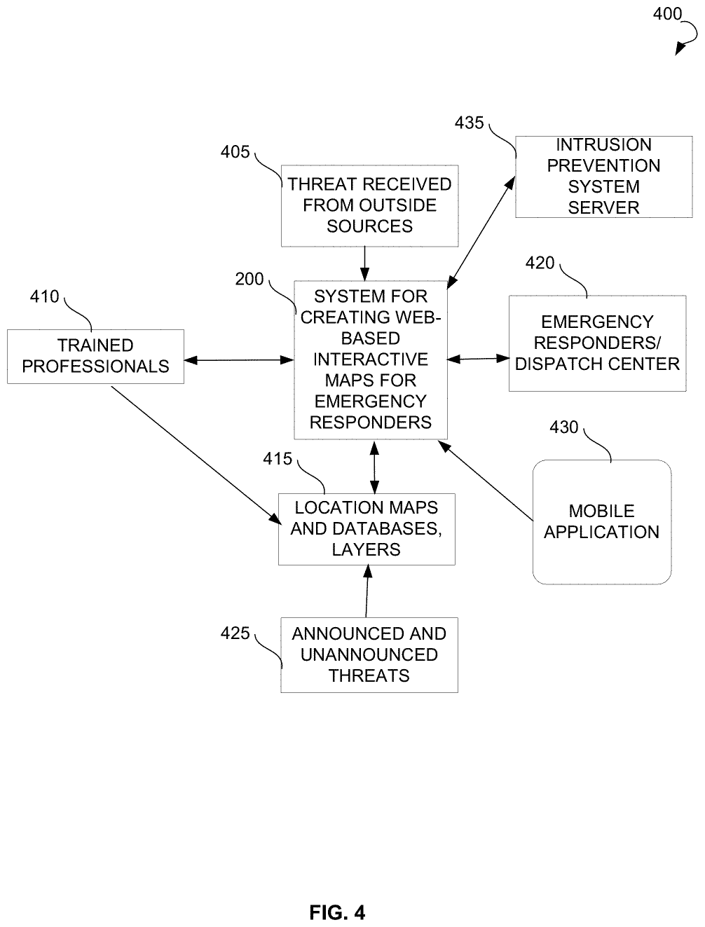

FIG. 4 is a block diagram 400 schematically showing communications between various parties and a system for creating web-based interactive maps for emergency responders, according to an example embodiment. Data concerning a threat (or an incident) may be received by the system 200 from an outside source, e.g., from a social network or a mobile application, such as Facebook or Safe2Tell, as shown by block 405. The system 200 may process the received data and exchange the data concerning the threat with trained professionals, such as mental health specialists, self-defense specialists, and the like, as shown by block 410. The trained professionals may provide recommendations on dealing with the threat.

The system 200 may provide the data concerning the threat and information received from trained professionals to a database and a map generation unit to generate a web-based interactive map, as shown by block 415. The web-based interactive map may include a plurality of layers. Different emergency responders can have access to different views depending on their role. Thus, each layer may be made available to specific emergency responders, dispatch centers, and/or approved users, such as local or state law enforcement, fire department, police department, an emergency management system, a school administration, and so forth, as shown by block 420.

Announced and unannounced threats may be received and collected by the system 200 as shown by block 425. The data concerning the threat can be received from an emergency responder, a site administrator, an individual, and so forth. The system 200 may be communicatively connected to various applications, e.g., Facebook, to monitor for threat triggers. For example, an unannounced threat may include a sudden appearance of an armed intruder.

A mobile application may be in constant communications with the system 200, as shown by block 430. The mobile application may be running on user devices of emergency responders, employees, students, individuals approved and present on-site, and so forth. In an example embodiment, the mobile application may operate in a listening mode and function as a sensor for collection of additional data related to the threat. The collected data can be transmitted to the system 200.

The web-based interactive map may be generated as follows. A location map of an area associated with the threat may be obtained from a third party, e.g., from a search web site, such as Google. Any web browser can be used to view location maps. A site administrator associated with the location may upload a floor plan. In an example embodiment, the floor plan may not be to scale, but rather a close representation of the building. The system 200 may place the floor plan on the location map (e.g., taken from Google Earth) and add various icons representing assets important to emergency responders.

If the location does not have sensors tracked by the system 200, the emergency responder (e.g., a firefighter) can open the mobile application and access the web-based interactive map that will display information relevant to this specific emergency responder, for example, water hookups, chemicals storages, and so forth.

The site administrator can log threats in the database as the threats are received. For example, a student can get into a fight and threatens somebody at a school. The site administrator can log the incident, create a report, and store the report in the database. A school superintendent can generate reports from schools and visualize the status of different threats. These data can be used to determine needed resources, for example, mental health experts, self-defense experts, level of effort, trained personnel needed to mitigate the threat, and so forth. The data concerning the threat can be viewable by law enforcement, which can decide whether to dispatch a responder.

The system 200 can be used for military facilities that have multiple buildings and secured gates such that law enforcement may be immediately notified when a gate is opened and where certain buildings are located and may zoom into the web-based interactive map for additional details.

A map view shown on one of the layers may include an aerial view of the location with the floor plan overlay. Different icons can identify the locations of assets, legends, numbers of buildings/rooms may be placed onto the web-based interactive map. The labels can change a status, e.g., from ‘threat’ to ‘clear’, based on a click on the legend of the map or an oral input, e.g., “Library clear”. The sensors may provide a status (e.g., “clear”) and environmental data.

In an embodiment when the facility has sensors tracked by the system 200, the capability of the floor plan may be supplemented with the ability to perform active and/or passive scanning. Passive scanning includes tracking wireless-enabled devices inside the facility. The active and/or passive scanning may be used to detect people moving inside the facility. The sensors may include Wi-Fi signal detectors, gunshot sensors, and listening devices.

A wireless-enabled device can include any device capable of communicating over any type of wireless network. For example, a wireless-enabled device may comprise a smartphone, tablet, smartwatch, laptop computer, Nest or other smart thermometer, voice activated digital assistant (like Amazon Echo, Google Home), network printer, 2-way radio, router, smart TV, smart appliance, automobile, drone, or any other item with wireless communication capability. In various embodiments, a wireless-enabled device can communicate over at least one type of wireless network, such as Wi-Fi network, Bluetooth, Radio Frequency Identification, radio, cellular network, and so forth.

It may be advantageous to monitor the wireless-enabled devices present in a physical space and the movement of those devices. For example, during an emergency situation (e.g., an active shooter situation), it can be useful to know that one particular wireless-enabled device is moving around the building, while other wireless-enabled devices are staying in approximately the same spot. This indicates a high probability that the moving wireless-enabled device belongs to the shooter and can provide additional information for authorities to estimate where to find the shooter.

In other types of emergencies, such as a structural damage to a building during a severe weather event or earthquake, knowing the location of wireless-enabled devices may help first responders to know where to look for people who are trapped, because wireless-enabled devices are likely to be on or near such people.

Passive Scanning/Tracking. In a passive tracking mode, a plurality of sensors (at least three for triangulation) intercept a wireless signal from a wireless-enabled device. The Received Signal Strength Indicator (RSSI) is a measurement of how well a sensor can sense a signal from a wireless-enabled device. An RSSI value can be pulled from a Wi-Fi card of the wireless-enabled device. This received RSSI value can be converted into a measurement. Each sensor transmits information regarding the RSSI signal strength (power of signal intercepted), along with a MAC (Media access control) address for the device from which the signal was intercepted to an IPS (Intrusion Prevention System) server 435 to process the information and determine a location of the device associated with the MAC address.

In various embodiments, the IPS server 435 utilizes triangulation (or trilateration) methods to determine a location of the device associated with the MAC address. The location of the wireless signal can be determined from the known locations of the sensors in the physical space, as well as the known map of the physical space.

The IPS server 435 may also have RSSI fingerprinting data so it can determine a probability that the device with the intercepted MAC address is actually at the determined location.

While the above description discusses intercepting a single wireless signal from one device with an associated MAC address, there can be many wireless signals detected from a plurality of wireless-enabled devices located in the physical space. Additionally, there can be multiple wireless signals from one device, such as Wi-Fi and Bluetooth (BLE).

Active Tracking. In an active tracking mode, system 200 may utilize an application installed on user device(s) 104 and/or 108. When the application on the user device(s) 104 and/or 108 is activated, it can send out a signal that is picked up by one or more sensor(s) 112 or access point(s) in the space. Since the application operating on the user device 104 and/or 108 is a trusted software program, the wireless signal transmitted by the user device 104 and/or 108 contains the actual MAC address for the user device 104 and/or 108. In this way, the system 200 can learn which wireless-enabled devices are present in a physical space, their respective locations, and their respective MAC addresses.

In some embodiments, the system 200 can cross-check results from active scanning with the passive scanning results. For some wireless-enabled devices that are in a similar location within a similar time period, the MAC addresses can be compared and the active scanned MAC address can replace the passive scanned MAC address received, if they are in conflict.

In one example, 10 wireless-enabled devices are activated when the application is launched and are actively being tracked. The system 200 may determine that only 6 of the MAC addresses received from the active scanning results are present in its generated list of present wireless-enabled devices. The system 200 may then conclude that the other 4 wireless-enabled devices present and enabled for active scanning have spoofed MAC addresses in passive scanning results.

In addition, the system 200 may do a request/send operation to 4 wireless-enabled devices present and enabled for active scanning, but whose MAC addresses are not present in the passive scanning results. In the request/send operation, the system 200 may send the MAC address received from active scanning results to the respective wireless-enabled device to confirm whether it is in fact the actual MAC address for that device. In this way, a legitimate pool of MAC addresses not picked up from passive scanning can be generated. By utilizing a combination of active scanning and passive scanning for wireless-enabled devices, the actual number of present wireless-enabled devices, their corresponding MAC addresses, and their locations can be determined with more precision and granularity. Further, active scanning results assist in narrowing a list of devices with spoofed MAC addresses.

In various embodiments, the user device 104 and/or 108 may send out a wireless signal for active scanning on a periodic time interval when the app is turned on. The periodic time interval can range from 5 seconds to 120 seconds, in various embodiments. The periodic time interval can be customizable by the administrative user 102 and/or system 200. Further, the periodic time interval can be customizable based on external factors such as wireless signal strength for the user device 104 and/or 108, battery life of the user device 104 and/or 108, data usage, and any other factor related to user device 104 and/or 108.

Utilizing embodiments of the present disclosure, the location of wireless-enabled devices can be monitored such that the system 200 can discern which wireless-enabled devices are stationary and which ones are moving. Retrieved information from sensors can be gathered and analyzed to determine a device type for various wireless-enabled devices detected. For example, a wireless-enabled device may be a router. The system 200 can refer to a table of known access points in a physical space and determine which wireless-enabled devices should be moving (e.g., smartwatch) and which wireless-enabled devices should not be moving (e.g., router). By detecting wireless-enabled devices in a physical space, and tracking movement of those wireless-enabled devices, a degree of vulnerability can be discerned for the physical space, and whether a concerning situation may be occurring within the physical space.

In an example embodiment, Bluetooth radios carried by the emergency responders may allow a dispatch center operator to visualize the location of the emergency responders on the map. Furthermore, the emergency responders may be identified to determine which emergency responder is in better position to respond to the threat because the emergency responder is closer to the threat.

For example, a call informing about a threat and a specific person associated with the threat may be received by the system 200. The caller may inform that hostages are held by a certain person in library or a school. An image or a picture of the person may be taken at school by sensors and provided to the system 200. The system 200 may attach the image to the threat report and provide the threat report to emergency responders. While the emergency responders are on their way to the school, the emergency responders may receive the image of the person they believe is responsible for the threat and the location of where that library is in the school. Thus, when the emergency responders enter a space, the emergency responders can quickly navigate to a place where the person is located.

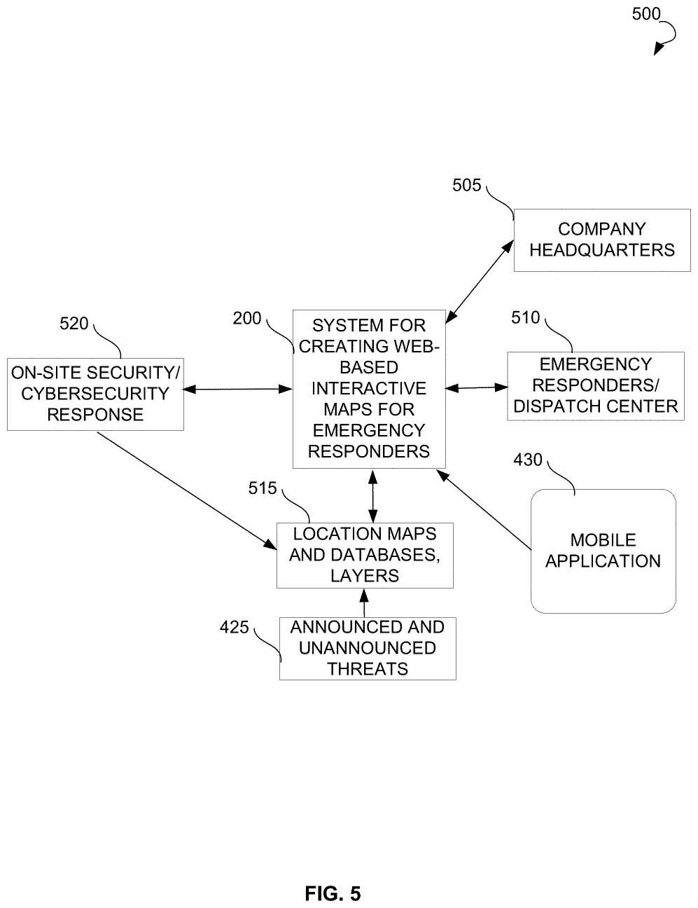

FIG. 5 is a block diagram 500 schematically showing communications between various parties and a system for creating web-based interactive maps for emergency responders in case of a threat occurring at highly secure locations, according to an example embodiment. In an embodiment relating to highly secure locations, the system 200 may be located onsite only instead of a cloud.

The system 200 may optionally exchange information with company headquarters, as shown by block 505. Furthermore, the system 200 may be in communication with emergency responders, as shown by block 510. The system 200 may receive threat information from company headquarters or law enforcement. Data concerning the threat may be shown on different layers of the web-based interactive map, as shown by block 515. The layers can be selected based on specifics of the location. Security responders or on-site security/cybersecurity can respond to the threat, as shown by blocks 520 and 510. The response from the on-site security/cybersecurity service may be provided based on data collected by sensors. The sensors may be configured to locate wireless device signals transmitted by printer Wi-Fi ports, wireless devices banned from the facility, wireless devices of intruders, and so forth.

The database may include history of threats, other historical data, records concerning different scenarios if law enforcement and dispatch are involved, clearing of rooms, officers' signals, signals and locations, interactions by dispatch, and so forth. The databased can store images of rooms cleared by the emergency responders, a list of rooms cleared, and time needed to clear the rooms. Additionally, the threat may be classified and a color may be assigned to the threat according to the classification.

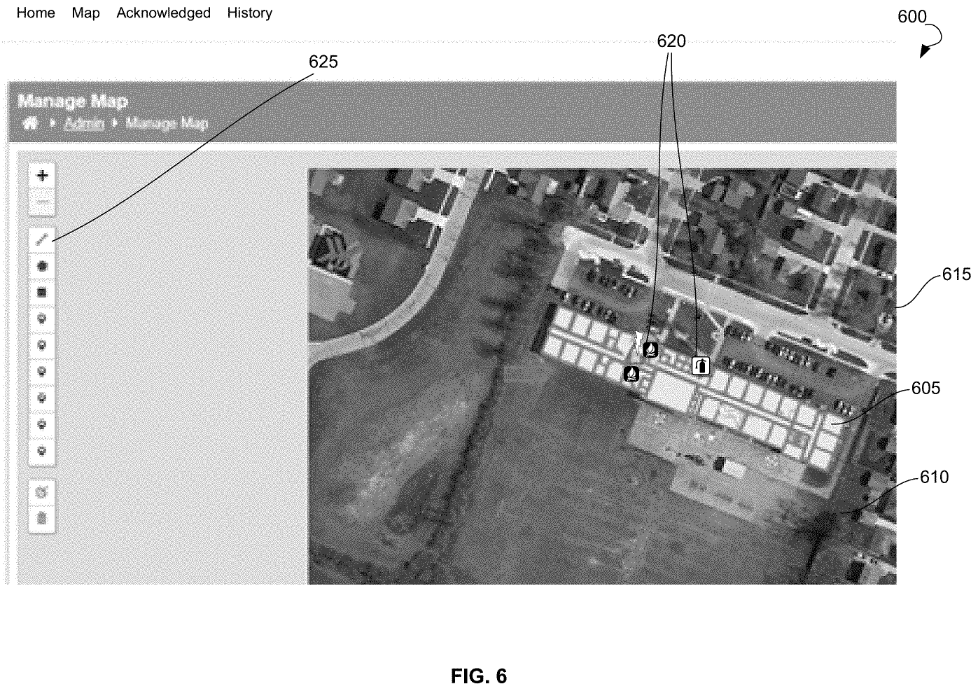

FIG. 6 is a block diagram schematically representing a user interface 600 shown on a user device of a site administrator, according to an example embodiment. In an example embodiment, the site administrator may be a person who manages a web-based interactive map on-site. A floor plan 605 (e.g., in Joint Photographic Experts Group (JPEG) or portable network graphics (PNG) format) may be superimposed on a map 610 (e.g., a Google Earth image) to generate a web-based interactive map 615. Upon generation of the web-based interactive map 615, multiple tools to trace and edit the floor plan 605 can be added to the web-based interactive map 615. This may allow emergency responders having low data throughput bandwidth to receive the web-based interactive map 615. The user interface 600 may further have a legend tool 625 to create a list of room names with corresponding room numbers. Multiple icons 620 indicating assets, such as water hookup, lock box, flammable chemicals, AED, fire extinguisher, and so forth, may be shown on the user interface 600. The user interface 600 may be adopted as a platform for controlling physical devices in buildings, e.g., block doors, turn on light, and so forth. Additional icons may be added for security enhancements, such as classroom security locks, barricades, and so forth. Furthermore, data may be digitally provided via a video feed of a camera. The site administrator may add more icons and more layers of the web-based interactive map 615 for other uses, such as maintenance requests and so forth. The site administrator can create the web-based interactive map upon receipt data concerning an incident. The site administrator can edit the web-based interactive map on the backend and changes may be uploaded to the frontend to display the web-based interactive map to emergency responders.

The site administrator and/or approved users may click on a tab on the user interface 600 for recording a threat or incident to a threat database. The threat database may be stored in the cloud and/or on a server, virtual servers, and so forth. The information stored in the threat database may be available to first responders and dispatchers. The access to the threat database may be controlled based on a user role hierarchy. Additionally, users may upload images to the threat database.

Multiple layers of the web-based interactive map may by generated based on a role of a person for which the layer in intended (first responders and dispatchers). For example, a fire department may not need to know how many devices are in a room, but is concerned about the structural integrity of the building, e.g., whether the building is on fire, whether an HVAC system may fall through and injure people, whether all people are out of the building. The police department may see, for example, where the active threats are, what rooms are cleared, and where armed assailants are located. Teachers and the school staff may also view relevant information, such as fire alarms, location of sprinklers and HVAC system, information concerning weapons concealed on-site (firearms that are carried by the teachers), and so forth.

Unique identifiers may be tied to each incident and, if known, person or persons involved in the incident. The threat database may track and connect all associated incidents. The threat database may track students based on their historical data regardless of the location. For example, a student may threaten violence at a school and then transfer to another school. The site administrator will be able to enter the unique identifier of the student to search for related incidences associated at other locations. If someone is in possession of a gun and there is an active shooter incident at the location, the information may be stored to the threat database for the specific location for a period of time or indefinitely.

In an example embodiment, the web-based interactive map may be also available for training. Specifically, the web-based interactive map may be always available, active, and viewable by all users across all roles. For example, for training purposes, employees of a fire department may be able to review the web-based interactive map showing a facility map to familiarize themselves with the facility in the event of an incident. The sensor data may be stricter controlled, for example, the sensor data may be not shown or partially shown on the web-based interactive map when the web-based interactive map is used for training purposes.

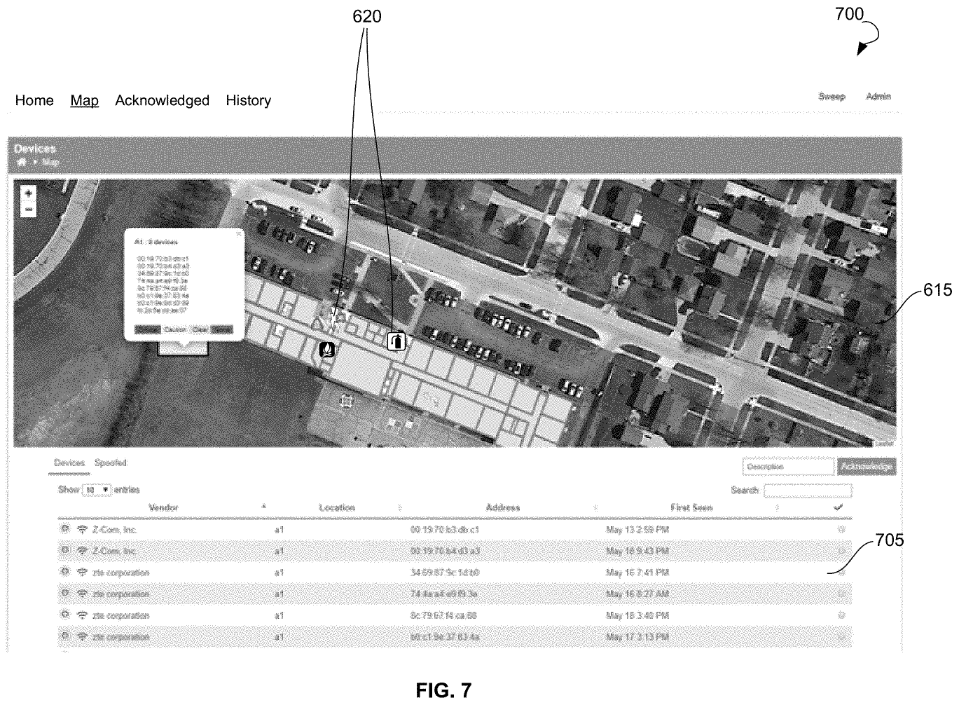

FIG. 7 is a block diagram schematically representing a user interface 700 shown on a user device of an emergency responder, according to an example embodiment. A facility may be not equipped with sensors tracked by the system for creating web-based interactive maps for emergency responders. The user interface 700 may show a web-based interactive map 615 with multiple icons 620 indicating assets on the facility.

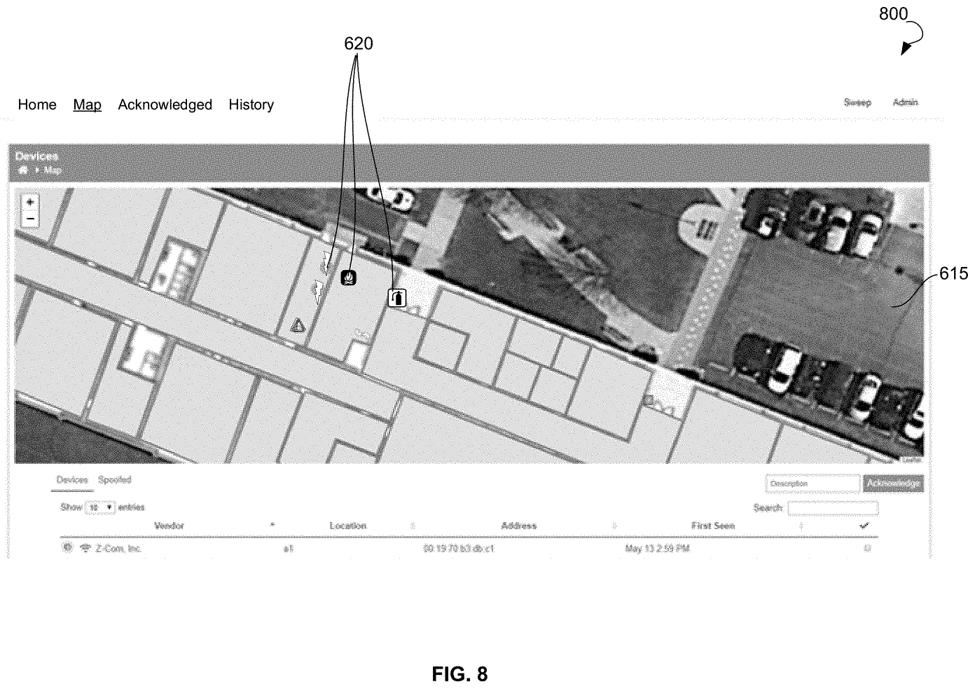

A site administrator may determine the best view for the emergency responder based on the incident. FIG. 8 shows a user interface 800 representing a scaled-up view of the web-based interactive map 615.

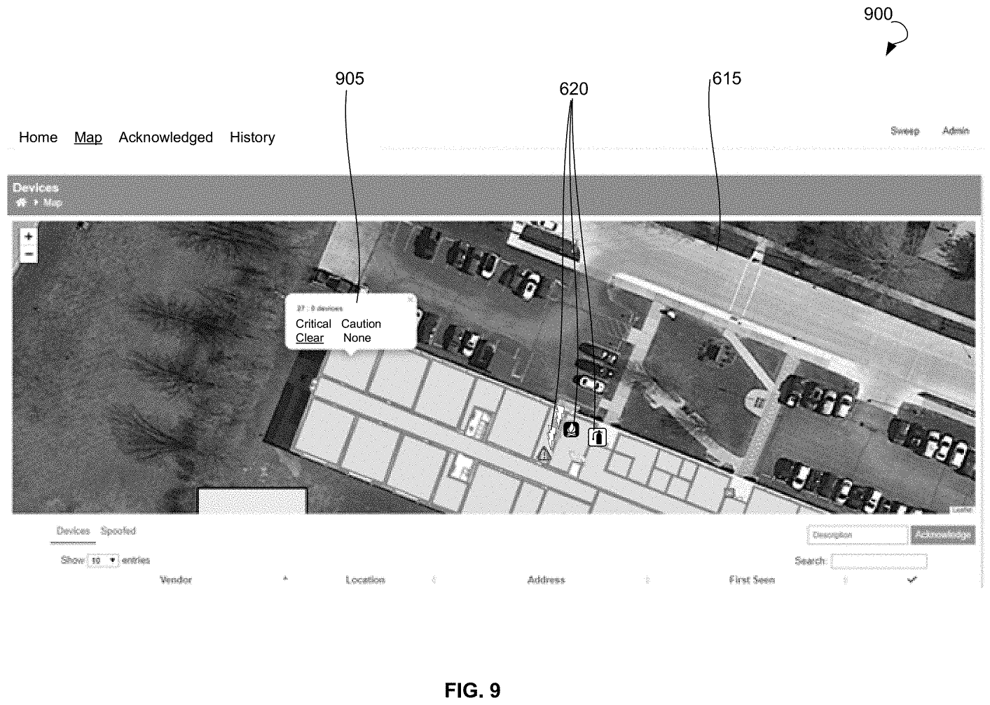

The site administrator or approved users working with emergency responders can mark a room as cleared or add other critical information, such as a location of victims, current location of a shooter. The history data associated with the incident may be stored to the databased for later use. FIG. 9 shows a user interface 900 representing a web-based interactive map 615 with a widget 905 for marking a room in the building. For example, the site administrator or the approved users may mark the room as ‘critical,’ ‘caution,’ ‘clear,’ ‘none,’ and so forth.

In an example embodiment, the facility may be equipped with sensors tracked by the system for creating web-based interactive maps for emergency responders. A plurality of sensors, e.g., chemical sensors, heat sensors, and motion sensors may provide information indicative of locations where people are hiding/present. The site administrator may be capable of viewing signals from devices and dispatch first responders to the locations identified by sensors. As shown in FIG. 7, a list 705 of devices present within the facility may be shown on the user interface 700. Additionally, the site administrator may make the location of the device available for the emergency responder. Specifically, the location of the devices may be shown on the web-based interactive map. The site administrator may relay critical information to a requesting officer. Additionally, the site administrator at the location may interact with sensor information with or without information added by a dispatcher.

In an example embodiment, the system for creating web-based interactive maps for emergency responders may be used for complex sites, such as a military facility or a DoD contractor. The web-based interactive map may be available to on-site private security services only and may additionally show all buildings and assets (e.g., site natural gas shut-off), security gates, with ability to interact with entrances for emergency responders. The threat database may be available to internal security personnel with ability to share with the emergency responders and/or dispatchers. Unique identifiers may be tied to each incident and location and, if known, person or persons involved in incidents. The threat database may track and connect all associated incidences. For example, an ex-employee may threaten violence at a place of former employment and then start working at another site. The site administrator will be capable of entering unique identifier of the employee to search for related incidences associated with the employee at other locations.

The site administrator may be able to interface with a dispatch center and mark security gates that are open. Alternatively, the site administrator may transfer the control to the dispatch center and the dispatch center can mark security gates on the map, such that law enforcement en route may know which gate to approach to get to a target building. Various icons, additional icons for security enhancements, security locks, and barricades may be displayed on the web-based interactive map. In further example embodiments, the control by the dispatch center of clearing and entering incident information can be transferred to a law enforcement and/or emergency responder mobile command set up on-site during significant events.

In an example embodiment, the web-based interactive map may be used to teach devices to respond and show up on the web-based interactive map. Thus, there can be a connection between how the web-based interactive map is created and the sensors showing up on the web-based interactive map. The sensors may monitor parking lots and exteriors of buildings to capture suspicious activity. Upon detecting a suspicious activity, an incident report may be generated. The site administrator may receive the incident report and involve other people in investigating the incident and taking actions. The site administrator may upload blueprints that may allow selecting utility types, for example, gas shut off, breaker boxes, fire hydrants, standing valves, HVAC systems, AEDs. Drawing tools may be provided on the user interface to draw the internal geometry of the actual blueprint. For example, for a school having a gym in the middle of the area, the site administrator can draw a polygon, and be prompted, by the user interface, to name the polygon, e.g., a gym. Once the site administrator completes drawing the internal geometry, the internal geometry or smart geometry using location data may be exported to the frontend, where the web-based interactive map may be made available to emergency responders based on their role.

The dispatchers may interact with all information present on the web-based interactive map and add additional information onto the map that the main dispatcher is using. For example, if somebody is actively in view of a shooter, the dispatcher may be able to put this information onto the map so that the dispatcher can instruct responding officers through the radio where to respond. Alternatively, the map can be provided directly to the first responder.

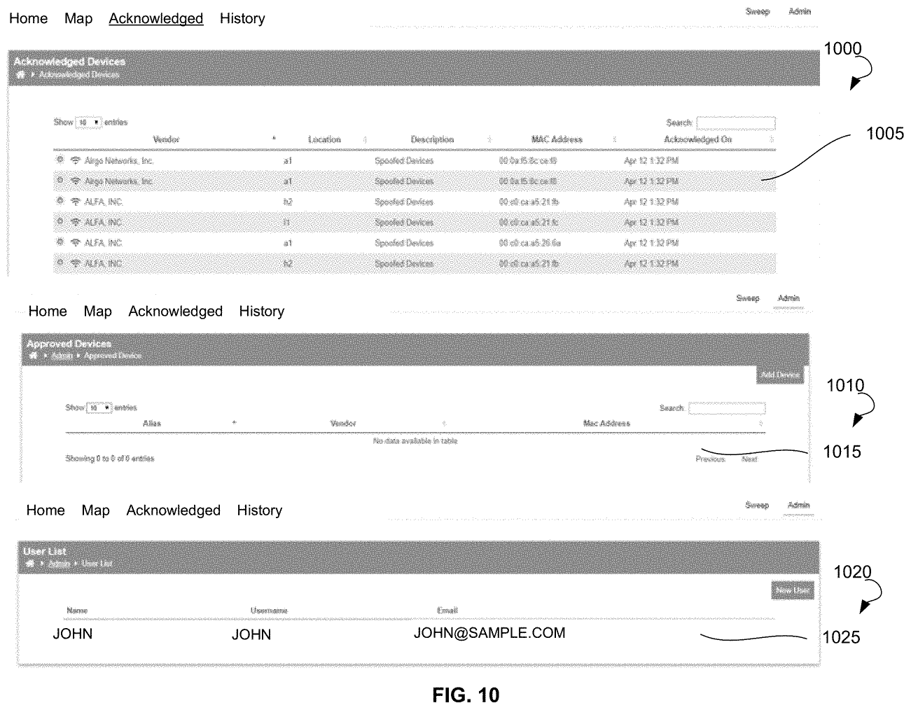

FIG. 10 is a schematic diagram representing a user interface shown on a user device of a site administrator or an emergency responder, according to an example embodiment. Specifically, FIG. 10 illustrates a user interface 1000 showing a list 1005 of acknowledged devices present in the facility. The acknowledged devices may also be shown on a web-based interactive map. FIG. 10 further illustrates a user interface 1010 showing a list 1015 of approved devices present in the facility. FIG. 10 also illustrates a user interface 1020 showing a list 1025 of users having access to the web-based interactive map, e.g., site administrators, approved users, and so forth.

Various embodiments of the present technology can be practiced with a local computer system, and/or a cloud-based system.

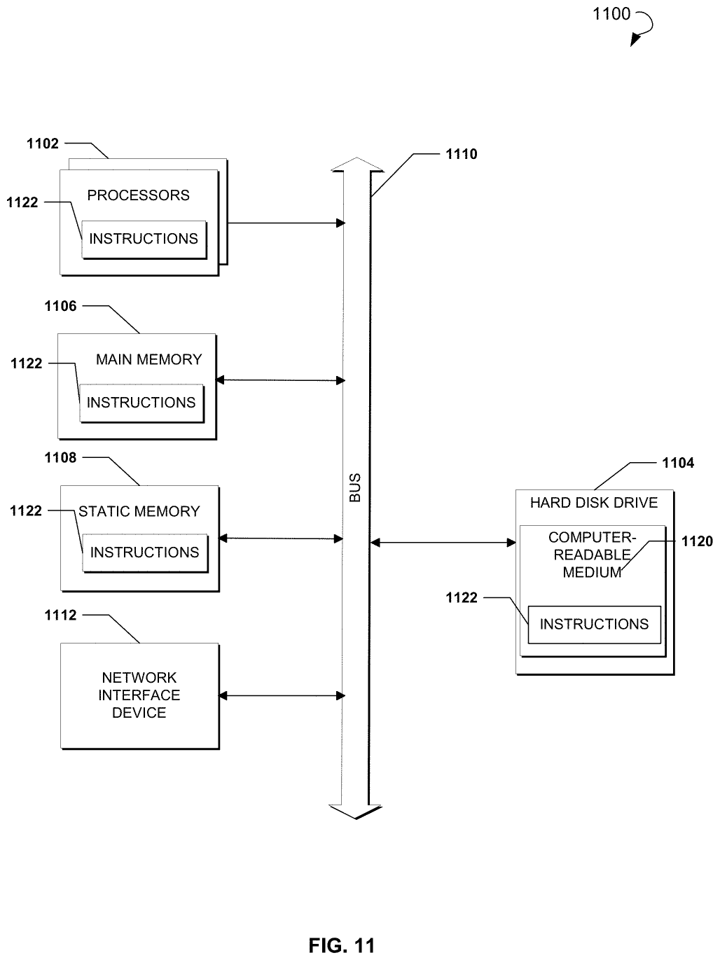

FIG. 11 shows a diagrammatic representation of a computing device for a machine in the exemplary electronic form of a computer system 1100, within which a set of instructions for causing the machine to perform any one or more of the methodologies discussed herein can be executed. Computing device 1100 may be administrative user device, client user device, or any of the servers discussed herein.

In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a personal computer (PC), a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor or multiple processors 1102, a hard disk drive 1104, a main memory 1106 and a static memory 1108, which communicate with each other via a bus 1110. The computer system 1100 may also include a network interface device 1112. The hard disk drive 1104 may include a computer-readable medium 1120, which stores one or more sets of instructions 1122 embodying or utilized by any one or more of the methodologies or functions described herein. The instructions 1122 can also reside, completely or at least partially, within the main memory 1106 and/or the static memory 1108 and/or within the processors 1102 during execution thereof by the computer system 1100. The main memory 1106, the static memory 1108, and the processors 1102 also constitute machine-readable media.

While the computer-readable medium 1120 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, JavaScript, Go, or other compilers, assemblers, interpreters or other computer languages or platforms.

The processing for various embodiments may be implemented in software that is cloud-based. In some embodiments, the computer system 400 is implemented as a cloud-based computing environment, such as a virtual machine operating within a computing cloud. In other embodiments, the computer system 400 may itself include a cloud-based computing environment, where the functionalities of the computer system 400 are executed in a distributed fashion. Thus, the computer system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 400, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN), a wide area network (WAN), a Metropolitan Area Network (MAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products, according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, systems and methods for creating web-based interactive maps for emergency responders are described herein. While various embodiments have been described, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the present technology should, therefore, be determined not with reference to the above description, but instead should be determined with reference to the appended claims along with their full scope of equivalents.

What is claimed is:

1. A method for creating web-based interactive maps for emergency responders, the method comprising:
receiving floor plan data associated with a facility;
based on the floor plan data, generating a floor plan of the facility;
creating an interactive web-based map of the facility by superimposing the floor plan onto a map of an area associated with the facility;
receiving locations of assets associated with the facility;
based on the floor plan data and the locations of assets, creating a plurality of layers of the interactive web-based map, each layer being labeled with icons identifying a selection of the assets, the selection corresponding to a role of an emergency responder;
receiving incident data associated with the facility; and
in response to the receipt of the incident data, making one or more of the plurality of layers of the interactive web-based map available to the emergency responder based on the role of the emergency responder.

2. The method of claim 1, wherein the incident data is provided by one or more of the following: a dispatcher, a site administrator, and an approved user.

3. The method of claim 1, wherein the interactive web-based map is controlled by a dispatcher or a site administrator, a control of the interactive web-based map being transferrable between the dispatcher and the site administrator.

4. The method of claim 3, wherein the floor plan is generated based on data received from a facility administrator or automatically generated using imagery received from a third party.

5. The method of claim 1, wherein each layer of the plurality of layers of the interactive web-based map incorporates historical threat data relevant to the emergency responder associated with the interactive map layer.

6. The method of claim 1, wherein the interactive web-based map is displayed on a user interface associated with a mobile application.

7. The method of claim 1, wherein the incident data includes sensory data provided by one or more sensors installed inside or outside the facility, the one or more sensors including one or more of the following: a mobile phone uploading incident related data, a chemical sensor, a heat sensor, and a motion sensor.

8. The method of claim 7, wherein the one or more sensors are configured to locate wireless device signals transmitted by one or more of the following: a printer Wi-Fi port, a wireless device banned from the facility, a wireless devices of intruder, and a wireless device of an emergency responder.

9. The method of claim 1, wherein the facility includes one of the following: a school, a place of worship, a business, a building, a military facility, and a Department of Defense (DoD) contractor.

10. The method of claim 1, wherein the emergency responder includes at least one of the following: law enforcement (LE), fire department (FD), police department (PD), an emergency management system (EMS), a school administration, a trained professional, a mental health professional, company headquarters, onsite security, and an automated cybersecurity responder.

11. The method of claim 1, further comprising compiling a threat database, the threat database including announced threats and unannounced threats, unique identifiers for persons associated with threats, persons involved, unique identifiers tied to each incident, students, employees associated with one or more incident locations, views of locations, locations of persons, incidents, images, incident reports, historical threat data, scenarios of law enforcement and dispatch involvement, records of clearing of rooms and associated signals and devices, records associated with locations, records of interactions by a dispatch, a threat level, and threat level color classifications.

12. The method of claim 11, where the threat data is received from a social network.

13. The method of claim 1, wherein the assets associated with the facility include one or more of the following: a water hookup, a lock box, a flammable chemical, an Automated External Defibrillator (AED), a gas shut off, a breaker box, a fire hydrant, a standing valve, a Heating, Ventilation, and Air Conditioning (HVAC) system, a fire extinguisher, a chemical storage, a security lock, a barricade, and a security gate.

14. The method of claim 1, wherein the interactive web-based map allows one or more of the following: interacting and controlling the assets through icons, updating the interactive web-based map based on interactions with the emergency responder, marking of the web-based interactive map with a current location of a victim or a perpetrator, controlling physical devices in the facility, connecting digitally to a video feed of a camera, displaying signals from electronic devices on the web-based interactive map, and changing statuses of one or more of the assets.

15. A system for creating web-based interactive maps for emergency responders, the system comprising:
a processor configured to:
receive floor plan data associated with a facility;
based on the floor plan data, generate a floor plan of the facility;
receive locations of assets associated with the facility;
receive incident data associated with the facility; and
in response to the receipt of the incident data, make one or more of a plurality of layers of an interactive web-based map available to an emergency responder based on a role of the emergency responder;
a map generation unit configured to:
create the interactive web-based map of the facility by superimposing the floor plan onto a map of an area associated with the facility; and
based on the floor plan data and the locations of assets, create the plurality of layers of the interactive web-based map, each layer being labeled with icons identifying a selection of the assets, the selection corresponding to the role of the emergency responder; and
a database configured to store at least the interactive web-based map, the locations of the assets, and the incident data.

16. The system of claim 15, wherein the interactive web-based map is controlled by a dispatcher or a site administrator, a control of the interactive web-based map being transferrable between the dispatcher and the site administrator.

17. The system of claim 15, wherein the floor plan is generated based on data received from a facility administrator or automatically generated using imagery received from a third party.

18. The system of claim 15, wherein each layer of the plurality of layers of the interactive web-based map incorporates historical threat data relevant to the emergency responder associated with the interactive map layer.

19. The method of claim 15, wherein the incident data includes sensory data provided by one or more sensors installed inside or outside the facility, the sensors including one or more of the following: a mobile phone uploading incident related data, a chemical sensor, a heat sensor, and a motion sensor.

20. A system for creating web-based interactive maps for emergency responders, the system comprising:
a processor configured to:
receive floor plan data associated with a facility;
based on the floor plan data, generate a floor plan of the facility;
receive locations of assets associated with the facility;
receive incident data associated with the facility; and
in response to the receipt of the incident data, make one or more of a plurality of layers of an interactive web-based map available to an emergency responder based on a role of the emergency responder, wherein each layer of the plurality of layers of the interactive web-based map incorporates historical threat data relevant to the emergency responder associated with the interactive map layer;
a map generation unit configured to:
create the interactive web-based map of the facility by superimposing the floor plan onto a map of an area associated with the facility; and
based on the floor plan data and the locations of assets, create the plurality of layers of the interactive web-based map, each layer being labeled with icons identifying a selection of the assets, the selection corresponding to the role of the emergency responder;
one or more sensors installed inside or outside the facility, the one or more sensors being configured to provide sensory data, the sensory data including the incident data; and
a database configured to store at least the interactive web-based map, the locations of the assets, and the incident data.
